(19) United States
(12) Patent Application Publication
(10) Pub. No.: US 2008/0011598 A1
(43) Pub. Date: Jan. 17, 2008

(54) Freshwater Recycling System

(76) Inventor: Chun Jung Chen, Tucheng City (TW)

Correspondence Address: HDSL, 4331 STEVENS BATTLE LANE, FAIRFAX, VA, 22033, US

(21) Appl. No.: 11/457,205

(22) Filed: Jul. 13, 2006

(51) Int. Cl. B01D 3/00; B01D 35/06

(52) U.S. Cl. 202/176; 210/223; 210/175; 210/167.29; 210/182; 202/177

(57) ABSTRACT

A freshwater recycling system has an oscillatory still distilling water, and a cooling installation connecting to the oscillatory still through a pipe, for change vapor to liquid water. The oscillatory still has a heating element and an oscillatory lodestone accommodated in a distilling tank, a steam excluding opening at a top portion of the distilling tank and a drainpipe at a bottom portion of the distilling tank. The oscillatory lodestone is made from a natural magnet.

### BACKGROUND

The present invention relates to a freshwater recycling system, and more particularly to a freshwater recycling system having a lodestone.

Freshwater is an essential resource for human life, health, economic growth and the vitality of ecosystems. From social and economic perspectives, the needs for water supplies adequate for human uses, such as drinking water, industry, irrigated agriculture, hydropower, waste disposal, and the protection of human and ecosystem health, are critical. Water supplies are subject to a range of stresses, such as population growth, pollution, and industrial and urban development. Water takes many different shapes on earth: water vapor and clouds in the sky, waves and icebergs in the sea, glaciers in the mountain, aquifers in the ground, to name but a few. Through evaporation, precipitation, and runoff, water is continuously flowing from one form to another, in what is called the water cycle. The water cycle is a graphic representation of how water is recycled through the environment. Water molecules remain constant, though they may change between solid, liquid, and gas forms. Drops of water in the ocean evaporate, which is the process of liquid water becoming water vapor. Evaporation can occur from water surfaces, land surfaces, and snow fields, into the air as water vapor. Moisture in the air can condensate, which is the process of water vapor in the air turning into liquid water. Water drops on the outside of a cold glass of water are condensed water. Condensation is the opposite process of evaporation. Water vapor condenses on tiny particles of dust, smoke, and salt crystals to become part of a cloud. After a while the water droplets combines with other droplets and fall to Earth in the form of precipitation (rain, snow, hail, sleet, dew, and frost). Once the drop has fallen to Earth, it may go into an aquifer as ground water, or the drop may stay above ground as surface water. However, the process of water vapor in the air turning into liquid water can not be controlled by human. The freshwater environment is characterized by the hydrological cycle, including floods and droughts, which in some regions have become more extreme and dramatic in their consequences. Global climate change and atmospheric pollution could also have an impact on freshwater resources and their availability and, through sea-level rise, threaten low-lying coastal areas and small island ecosystems.

As the human population continues to grow exponentially, we encounter greater scarcities of water around the world. According to the United Nations Environment Programme (UNEP): two hundred scientists in 50 countries have identified water shortage as one of the two most worrying problems for the new millennium (the other was climate change). Unprecedented commitment on a global scale to innovate new water technologies and management systems is required to 1) preserve the quality of our current supplies, 2) reduce the demand for water through gains in efficiency, and 3) increase the overall quantity of freshwater available.

For increasing the overall quantity of freshwater available, seawater desalination technology is advancing quickly, which is an environmentally safe process that removes salts and other dissolved minerals from ocean water, and departs the saline water to fresh water and brine.

Reverse osmosis and electro dialysis are main techniques that can be applied for seawater desalination. Reverse osmosis is the most economic process for the desalination of brackish water and seawater. The Reverse Osmosis process uses a semi-permeable membrane to separate and remove dissolved solids, organics, pyrogens, submicron colloidal matter, viruses, and bacteria from water. The process is called “reverse” osmosis since it requires pressure to force pure water across a membrane, leaving the impurities behind. Reverse Osmosis is capable of removing 95%-99% of the total dissolved solids (TDS) and 99% of all bacteria, thus providing safe, pure water.

Electro Dialysis (ED) is a membrane process, during which ions are transported through semi permeable membrane, under the influence of an electric potential. The membranes are cation- or anion-selective, which basically means that either positive ions or negative ions can flow through. Cation-selective membranes are polyelectrolytes with negatively charged matter, which rejects negatively charged ions and allows positively charged ions to flow through. By placing multiple membranes in a row, which alternately allow positively or negatively charged ions to flow through, the ions can be removed from wastewater. In some columns concentration of ions takes place and in other columns ions are removed. The concentrated saltwater flow is circulated until it has reached a value that enables precipitation. At this point the flow is discharged. This technique can be applied to remove ions from water. Particles that do not carry an electrical charge are not removed.

There are several others different techniques that can be applied for water desalination. Examples are multi-stage flash desalination, distillation, ion exchange, freezing and solar still, etc. However, these equipments used in these techniques are complex and the costs are accordingly high. Thus, these techniques generally are not easy to use. Especially, seawater is easy to erode these equipments used thereof. Therefore, the service of these equipments is not convenient and the service cost is accordingly high.

Accordingly, what is needed is a freshwater recycling system that can overcome the above-described deficiencies.

### BRIEF SUMMARY

Accordingly, the present invention is to provide a freshwater recycling system, which is facility and conveniently in operation.

An exemplary freshwater recycling system has an oscillatory still distilling water, and a cooling installation connecting to the oscillatory still through a pipe, for change vapor to liquid water. The oscillatory still has a heating element and an oscillatory lodestone accommodated in a distilling tank, a steam excluding opening at a top portion of the distilling tank and a drainpipe at a bottom portion of the distilling tank. The oscillatory lodestone is made from a natural magnet.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, plan view of a freshwater recycling system according to a first embodiment of the present invention, the freshwater recycling system having a cooling installation and a oscillatory lodestone;

FIG. 2 is an enlarged, cross-sectional view of the cooling installation of the freshwater recycling system of FIG. 1;

FIG. 3 is an isometric view showing the cross-sectional structure of the cooling installation of FIG. 2;

FIG. 4 is a top plan view of the cooling installation of FIG. 2;

FIG. 5 is a schematic view showing the operation of the freshwater recycling system of FIG. 1;

FIG. 6 is a schematic, isometric view of the oscillatory lodestone of the freshwater recycling system of FIG. 1;

FIG. 7 is a schematic, cross-sectional view of the oscillatory lodestone of FIG. 5; and

FIG. 8 is an isometric view of a cooling installation of a freshwater recycling system according to a second embodiment of the present invention, showing a cross-sectional structure of the oscillatory lodestone.

### DETAILED DESCRIPTION

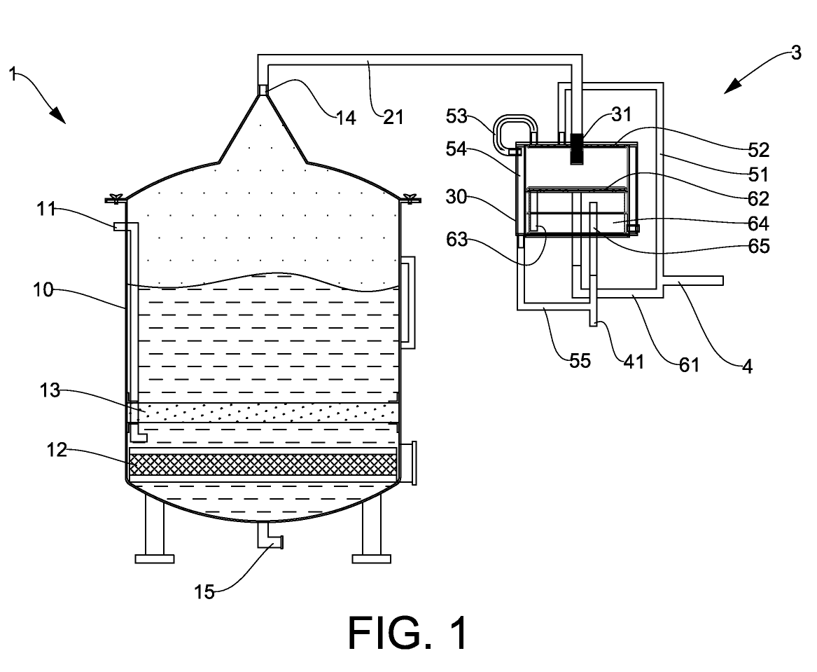

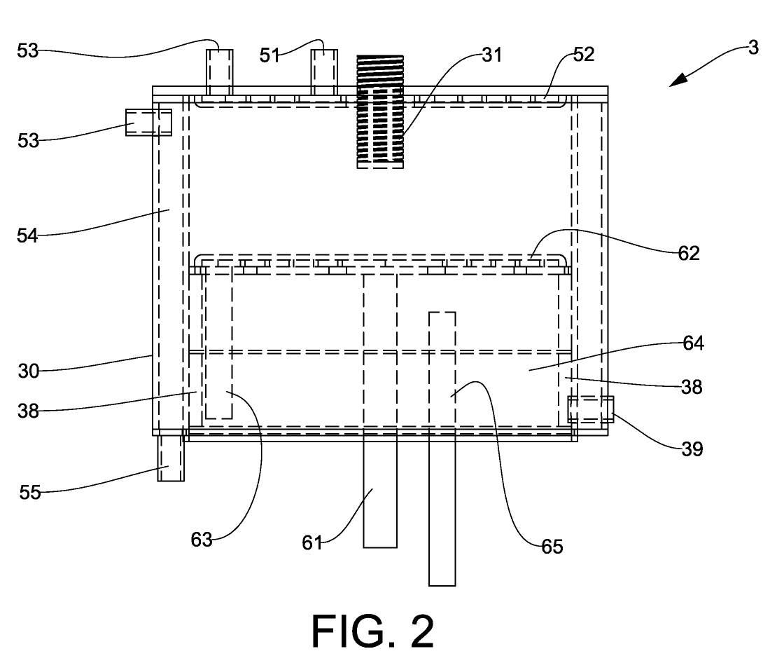

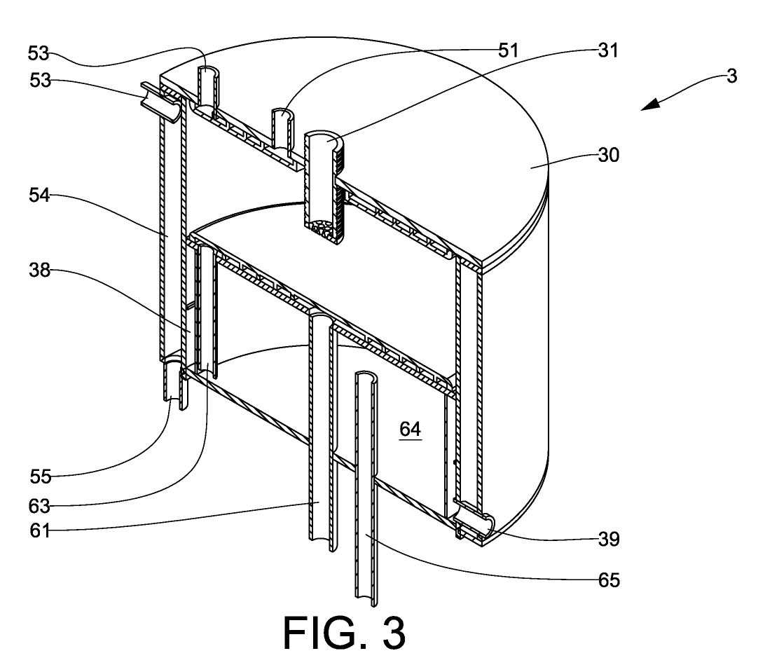

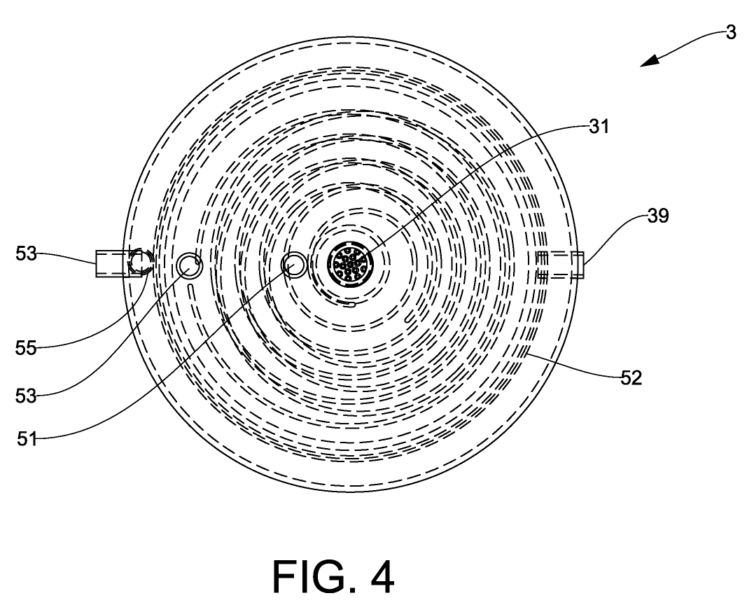

Referring to FIGS. 1-4, a freshwater recycling system according a first embodiment of the present invention has an oscillatory still 1 and a cooling installation 3 connecting with the oscillatory still 1 by a guiding pipe 21 therebetween.

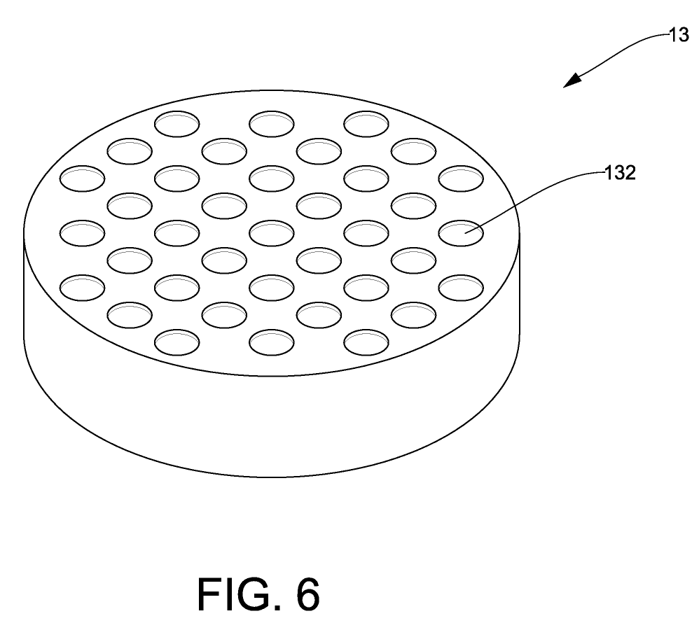

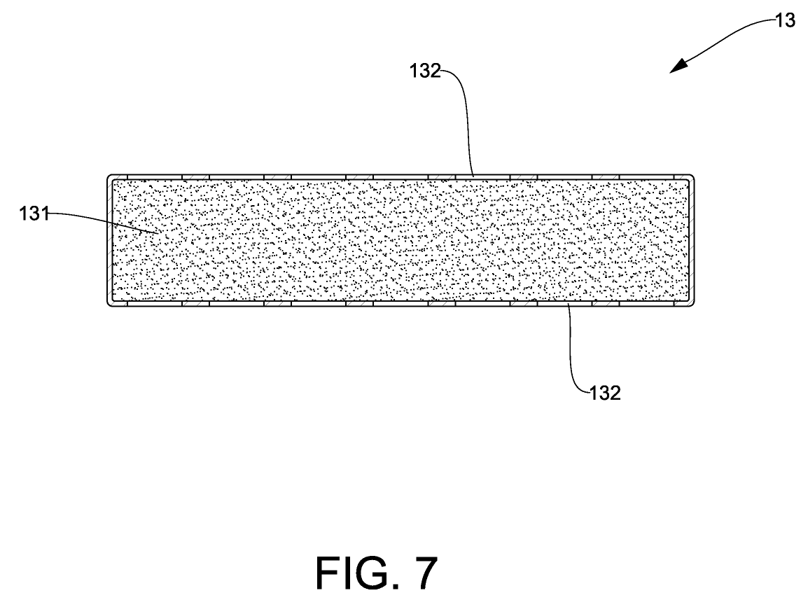

The oscillatory still 1 has a distilling tank 10, an input pipe 11 attached on the distilling tank 10, a heating element 12 and an oscillatory lodestone 13. The heating element 12 and the oscillatory lodestone 13 are accommodated in the distilling tank 10. The heating element 12 is used to heat the seawater accommodated in the distilling tank 10. The oscillatory lodestone 13 (as shown in FIG. 6 and FIG. 7) has a lodestone 131 and a housing 133 covering the lodestone 131. The housing 133 has a plurality of holes 132 distributed thereon for guiding water in and out. The lodestone 131 is made from natural magnet, and has a plurality of capillary aperture formed therein. When seawater pass through the capillary aperture, the lodestone 131 can absorb the dissolved metal molecular and other impurities. The distilling tank 10 has a steam excluding opening 14 at its top portion, and a drainpipe 15 at its bottom portion. The steam excluding opening 14 is used for excluding the heated vapor, and the drainpipe 15 is used for expelling the brine departed from the seawater.

The cooling installation 3 has a cooling tank 30, a sprayer 31 at a top portion of the cooling tank 30. The sprayer 31 is disposed at one end of the guiding pipe 21 for spraying vapor into the cooling tank 30. The cooling installation 3 further has a cooling-water entrance 4, a discharge pipe 41, a first branching pipe 51, a second branching pipe 61, a top cooling circulator 52, a side cooling circulator 54, a central cooling circulator 62, a storage tank 64, a freshwater-guiding chamber 38, and a freshwater spout 39. The cooling-water entrance 4 is disposed at outside of the cooling tank 30, for guiding cooling water, liquid nitrogen or gaseous nitrogen into the cooling installation 3. The top cooling circulator 52, the side cooling circulator 54, and the central cooling circulator 62 are fixed on or hanged on the top portion, a side portion, and a central portion of the cooling tank 30, respectively. The central cooling circulator 62 is under the sprayer 31. The storage tank 64 is formed at a bottom region of the cooling tank 31, and under the central cooling circulator 62. The first branching pipe 51 connects with one end of the top cooling circulator 52 and provides the cooling water into the top cooling circulator 52. Another end of the top cooling circulator 52 connects with the side cooling circulator 54 through a first feeding pipe 53. The side cooling circulator 54 connects with the discharge pipe 41 through a second feeding pipe 55. The first branching pipe 50, the top cooling circulator 52, the first feeding pipe 53, the side cooling circulator 54, the second feeding pipe and the discharge pipe 41 forms a first cooling circulating unit. The second branching pipe 61 connects with one end of the central cooling circulator 62, and another end of the central cooling circulator 62 connects with the storage tank 64 through a guiding pipe 63. The cooling installation 3 further has a flooding pipe 65, one end of the flooding pipe 65 inserting into the storage tank 64 and the other end of the flooding pipe 65 connecting with the discharge pipe 41. The second branching pipe 61, the central cooling circulator 62, the guiding pipe 63, the storage tank 64 and the flooding pipe 65 forms a second cooling circulating unit. The freshwater-guiding chamber 38 surrounds the storage tank 64 and connects with freshwater spout 39, which discharges the cooled freshwater flow out.

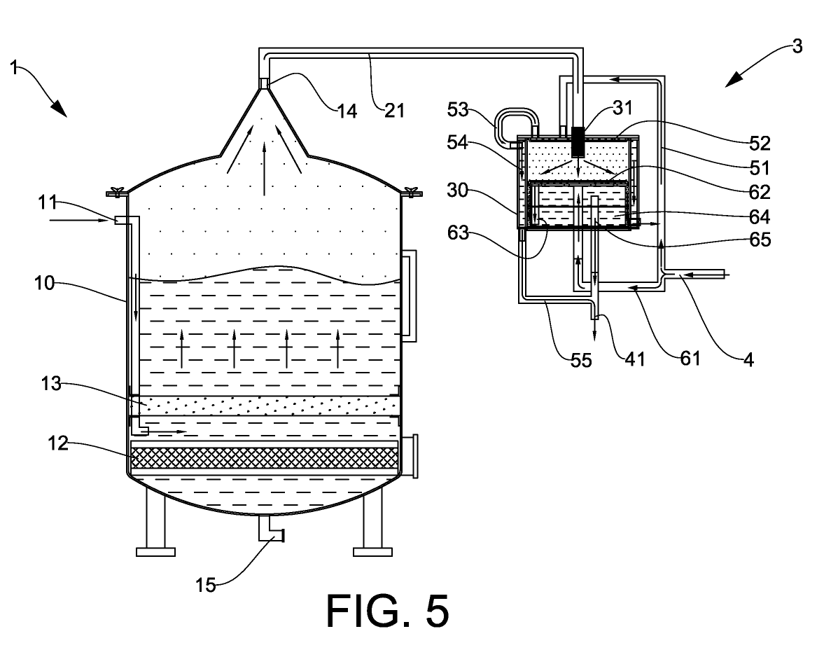

As shown in FIG. 5, seawater is guided into the distilling tank 10 and the heating element 12 is driven to heat and distill the seawater. The seawater rolls in the distilling tank 10 for temperature change thereof, and passes the oscillatory lodestone 13 to and fro. The oscillatory lodestone 13 decomposes the seawater molecular and absorbs the dissolved heavy metal molecular, organics, pyrogens, submicron colloidal matter, viruses and other impurities therein. When the seawater is boiled away, the water changes from a liquid state to a vapor state and the water vapor raises and is guided into the cooling installation 3 through the steam excluding opening 14 and the guiding pipe 21. After that, the water vapor is sprayed to the top cooling circulator 52, the side cooling circulator 54, and the central cooling circulator 62 by the sprayer 31 to cool, and then the water vapor is changed from a vapor state to a liquid state after the cooling process and is accommodated in the water-guiding chamber 38 and expelled out through the drinking-water spout 39. After the freshwater recycling process, the desalination process is finished. In the first cooling circulating unit of the cooling process, cooling water is guided into the first branching pipe 51, and sequentially flows through the top cooling circulator 52, the first feeding pipe 53, the side cooling circulator 54, the second feeding pipe 55, and then output from the discharge pipe 41. In the second cooling circulating unit of the cooling process, cooling water is guided into the second branching pipe 61, and sequentially flows through the central cooling circulator 62, the guiding pipe 63 to the storage tank 64. When the water-level of the cooling water in the storage tank 64 is higher than the height of the end of the flooding pipe 65, the cooling water is than output from the discharge pipe 41.

Because the freshwater recycling system utilize the oscillatory lodestone 13 to dissolve the seawater molecular and absorbs the dissolved heavy metal molecular, organics, pyrogens, submicron colloidal matter, viruses and other impurities therein, user just need take out the oscillatory lodestone 13 to clean for reuse. Therefore, the service process is simple and the service cost is low.

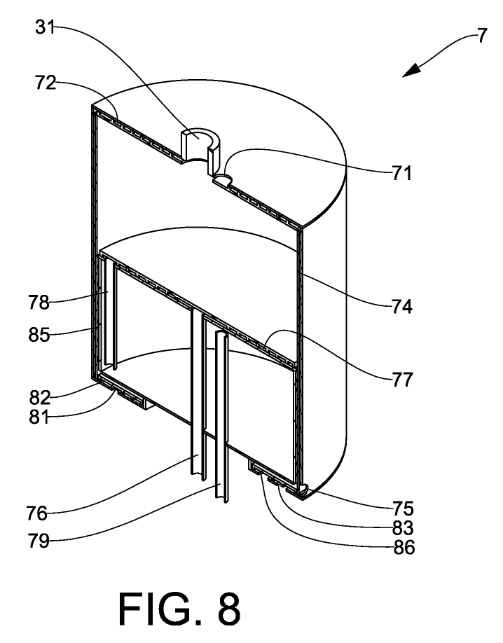

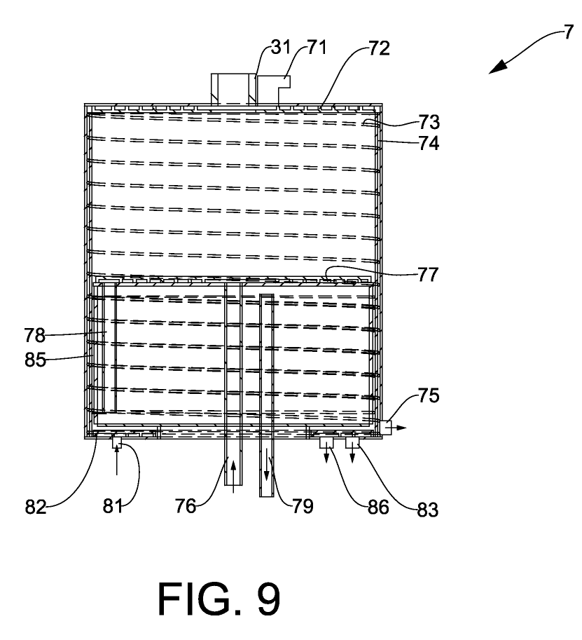

Referring to FIG. 8 and FIG. 9, a freshwater recycling system according a second embodiment of the present invention is shown. The freshwater recycling system has a cooling installation 7, which has a first cooling-water entrance 71, a top cooling circulator 72, a side cooling circulator 74, a first guiding pipe 73 and a first freshwater spout 75. The first cooling-water entrance 71, the top cooling circulator 72, the first guiding pipe 73, the side cooling circulator 74 and the first freshwater spout 75 orderly connects one by one and forms a first cooling circulator unit. The cooling installation 7 further has a second cooling-water entrance 76, a central cooling circulator 77, a second guiding pipe 78 and a second freshwater spout 79. The second cooling-water entrance 76, the central cooling circulator 77, the second guiding pipe 78 and the second freshwater spout 79 orderly connects one by one and forms a second cooling circulator unit. The cooling installation 7 further has a third cooling-water entrance 81, a bottom cooling circulator 82, and a third freshwater spout 83. The third cooling-water entrance 81, the bottom cooling circulator 82, and the third freshwater spout 83 orderly connects one by one and forms a third cooling circulator unit. The bottom cooling circulator 82 is disposed at a bottom portion of the cooling installation 7. The first, second and third cooling circulator units surrounds an overall inner surface (not labeled) of the cooling installation 7. Thus, the freshwater recycling system has a preferred cooling efficiency.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A freshwater recycling system, comprising:
an oscillatory still for distilling water, which comprises a heating element and a lodestone accommodated in a distilling tank, a steam excluding opening at a top portion of the distilling tank and a drainpipe at a bottom portion of the distilling tank; and
a cooling installation connecting to the steam excluding opening of the oscillatory still through a pipe, for changing water vapor to liquid water,
wherein the lodestone is made from a natural magnet.

2. The freshwater recycling system as claimed in claim 1, wherein the lodestone has a plurality of capillary apertures distributed therein.

3. The freshwater recycling system as claimed in claim 1, wherein the lodestone is accommodated in a housing, the housing having a plurality of holes thereon.

4. The freshwater recycling system as claimed in claim 1, wherein the cooling installation has a sprayer disposed on a top thereof.

5. The freshwater recycling system as claimed in claim 1, wherein the cooling installation has a first cooling unit, which comprises a first cooling-water entrance, a top cooling circulator, a side cooling circulator, a first guiding pipe and a first freshwater spout, orderly connecting with each other, the top cooling circulator being disposed on a top portion of the cooling installation, the side cooling circulator being fixed on an sidewall of the cooling installation.

6. The freshwater recycling system as claimed in claim 5, wherein the cooling installation further has a second cooling-water entrance, a central cooling circulator, a second guiding pipe and a second freshwater spout, orderly connecting with each other, the central cooling circulator being fixed on a central portion of the cooling installation.

7. The freshwater recycling system as claimed in claim 6, wherein the cooling installation further has a third cooling-water entrance, a bottom cooling circulator, and a third freshwater spout, orderly connecting with each other, the bottom cooling circulator being fixed on a bottom portion of the cooling installation.

8. The freshwater recycling system as claimed in claim 1, wherein the cooling installation has a top cooling circulator, a side cooling circulator, a central cooling circulator fixed on a top portion, a side portion, and a central portion of a cooling tank.

9. The freshwater recycling system as claimed in claim 8, wherein the cooling installation further has a bottom cooling circulator fixed on a bottom portion of the cooling tank.

10. The freshwater recycling system as claimed in claim 8, wherein the cooling installation has a first cooling circulating unit, which has a first branching pipe, the top cooling circulator, a first feeding pipe, the side cooling circulator, a second feeding pipe and a discharge pipe, orderly connecting one by one.

11. The freshwater recycling system as claimed in claim 10, wherein the cooling installation has a second cooling circulating unit, which has a second branching pipe, the central cooling circulator, a guiding pipe, a storage tank, a flooding pipe and the discharge pipe, orderly connecting one by one.

12. The freshwater recycling system as claimed in claim 11, wherein the storage tank is under the central cooling circulator.

13. The freshwater recycling system as claimed in claim 12, wherein the cooling installation further comprises a freshwater-guiding chamber surrounding the storage tank and connecting with a freshwater spout, which discharges the cooled freshwater flow out.
